(19) United States
(12) Patent Application Publication
(10) Pub. No.: US 2017/0097636 A1
(43) Pub. Date: Apr. 6, 2017

(54) MOBILE MONITORING SYSTEM

(71) Applicant: EMERALD INFORMATION SYSTEMS LTD., HAIFA (IL)

(72) Inventor: AMIR ALONI, HAIFA (IL)

(21) Appl. No.: 15/311,713

(22) PCT Filed: May 17, 2015
(86) PCT No.: PCT/IL2015/050522

§ 371 Date: Nov. 16, 2016

Related U.S. Application Data
(60) Provisional application No. 61/994,130, filed on May 16, 2014.

(51) Int. Cl. G05B 23/02

(52) U.S. Cl. CPC G05B 23/0216; G05B 2219/15045

(57) ABSTRACT

A system for monitoring at least one machine, the system comprising a central monitoring server and at least one mobile monitoring station, having at least one sensor and a wireless communication unit, wherein the at least one sensor monitors the at least one machine, and wherein monitoring information from the at least one sensor is wirelessly transmitted to the central monitoring server using the wireless communication unit.

### FIELD OF THE INVENTION

The present invention relates to monitoring of machinery. More particularly, the present invention relates to systems and methods for continuous mobile monitoring of machinery, and also mobile monitoring of operators of manual or automatic production.

### BACKGROUND OF THE INVENTION

Monitoring of industrial machinery (for instance in textile factories) or its peripheral units, is typically carried out by attaching a programmable logic controller (PLC) unit to these machines, and then retrieving data from the PLC unit for a central monitoring server. The PLC is a digital computer used for electromechanical processes, and designed for multiple inputs and output arrangements with programs to monitor machine operations (e.g. stored in non-volatile memory). Moreover, old machines having analog displays (for instance a pressure dial) cannot be properly monitored with a PLC, so that only partial monitoring is possible.

In a factory not equipped with any monitoring units, these PLC units are attached to the machinery (and/or peripheral units) with a physical electrical bond. These PLC units are usually further connected with a physical electrical bond to the central monitoring server. In order to create this electrical connection, a technician must connect to an existing port at the machine to the PLC, with a connection to the monitoring server. In case that the machines (and/or peripheral units) do not have an existing port, the technician must then mend the machinery by creating such a port which can require a long period of time with shutdown of the machinery. Furthermore, these electric connections require running electrical cables throughout the factory, from the machinery (and/or peripheral units) and to the monitoring server thus creating a complicated network of cables that requires a professional technician for maintenance. There is therefore a need for a monitoring solution that can be easily constructed for industrial machinery without the need of physical electric connections.

### SUMMARY OF THE INVENTION

According to a first aspect of the present invention, a system for monitoring of at least one machine is provided, the system comprising:

a central monitoring server; and

at least one mobile monitoring station, comprising:
at least one sensor;
a wireless communication unit,
   wherein the at least one sensor monitors the at least one machine, and wherein monitoring information from the at least one sensor is wirelessly transmitted to the central monitoring server using the wireless communication unit.

In some embodiments, the at least one mobile monitoring station is positioned in proximity to the at least one machine.

In some embodiments, the at least one mobile monitoring station comprises a computing device.

In some embodiments, the system further comprises an interactive display coupled to the central monitoring server, wherein the interactive display is configured to allow information to be sent to and retrieved from the central monitoring server.

In some embodiments, the system further comprises a wearable monitoring device wirelessly coupled to the central monitoring server, and mounted onto a moving article, wherein the wearable monitoring device is configured to monitor movement of the moving article.

In some embodiments, the moving article is the hand of an operator of the at least one machine.

In some embodiments, the moving article is a robotic arm of the at least one machine.

In some embodiments, the at least one sensor consists of at least one of the following components: a camera, a near field communication (NFC) sensor, a microphone, a gyroscope, and an accelerometer.

In some embodiments, the wireless communication unit consists of at least one of the following components: Wi-Fi unit, Bluetooth unit, and a cellular communication unit.

In some embodiments, the system further comprises a processing unit, and wherein the processing unit is configured to allow processing the monitoring information from the at least one sensor.

According to a second aspect of the invention, a method for monitoring is provided, the method comprising:

providing at least one sensor;
providing a wireless communication unit, coupled to the at least one sensor;

providing a central monitoring server;

initiating continuous monitoring with the at least one sensor;

processing the monitoring information;

wirelessly transmitting processed information to the central monitoring server using the wireless communication unit.

In some embodiments, the method further comprises recording a time stamp.

In some embodiments, the continuous monitoring comprises image capturing.

In some embodiments, the continuous monitoring comprises sound capturing.

In some embodiments, the information processing consists of at least one of the following techniques: image processing, movement detection, sound processing, and distance detection.

In some embodiments, the information processing comprises at least one of the following processes: barcode recognition, color recognition, optical character recognition (OCR), motion pattern recognition, location analysis, optical encoding, and frame location.

In some embodiments, the information processing comprises at least one of the following processes: motion gesture recognition, vibration pattern recognition, compass analysis, and global positioning system (GPS) recognition.

In some embodiments, the information processing comprises at least one of the following processes: sound pattern recognition, voice command recognition, and volume peak recognition.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 schematically illustrates a commercially available machinery monitoring system, according to an exemplary embodiment.

FIG. 2 schematically illustrates a mobile machinery monitoring system, according to an exemplary embodiment.

FIG. 3 shows a block diagram describing the monitoring process, according to an exemplary embodiment.

FIG. 4 schematically illustrates a mobile machinery monitoring system, which monitors two machines simultaneously, according to an exemplary embodiment.

FIG. 5 schematically illustrates a wearable monitoring device, according to an exemplary embodiment.

### DETAILED DESCRIPTION OF THE INVENTION

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For clarity, non-essential elements were omitted from some of the drawings.

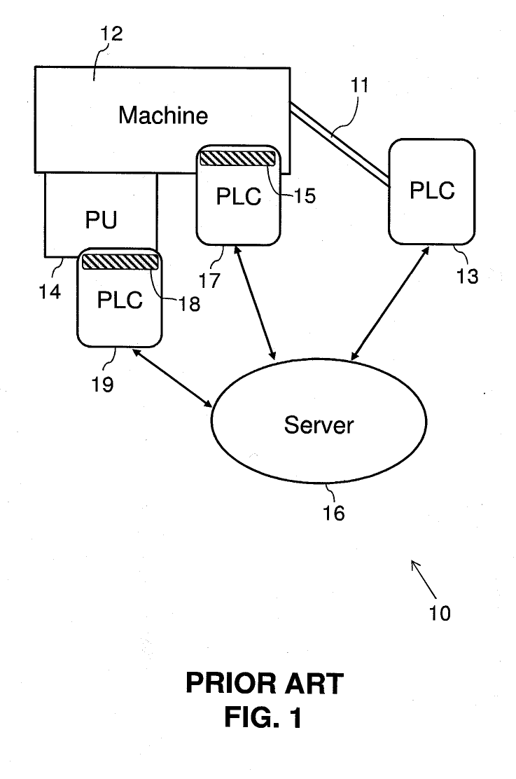

FIG. 1 schematically illustrates a commercially available machinery monitoring system 10, wherein the direction of arrows indicates the direction of information flow. A work center with a machine 12 is connected to a first programmable logic controller (PLC) unit 13 with a dry contact 11 (i.e. a relay not connected to a power source), and further directly connected to a second PLC unit 17. The first PLC unit 13 is monitoring “external” units, which are not available directly from the machine 12 such as counters and/or cycle timing, which typically don't send information back to the machine 12 and thus cannot be directly monitored.

The second PLC unit 17 is monitoring the machine 12 with a direct connection 15 to the circuit board of the machine 12. A third PLC unit 19 is monitoring a peripheral unit 14 of the machine 12, with another direct connection 18. Finally the first PLC unit 13, the second PLC unit 17, and the third PLC unit 19 transmit monitoring data to a central monitoring server 16 through direct electrical communication (or alternatively through wireless communication).

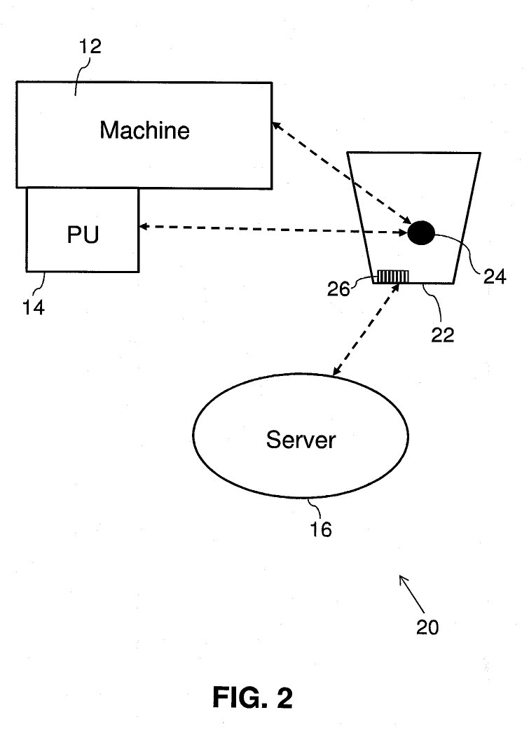

FIG. 2 schematically illustrates a mobile machinery monitoring system 20, wherein the direction of arrows indicates the direction of information flow. The mobile machinery monitoring system 20 may comprise at least one mobile monitoring station 22 that may be positioned in proximity to the machinery, for instance positioned in proximity to at least one machine 12. It should be noted that the coupling of the mobile monitoring station 22 to the machinery is carried out without physical connections to any machine (in contrast to the requirement for the commercially available monitoring system 10, as shown in FIG. 1).

The mobile monitoring station 22 may be equipped with at least one sensor 24, and may be any mobile computing device such as a tablet, a smartphone, or a digital camera. Once the mobile monitoring station 22 is properly positioned in proximity to the machinery (or mounted onto the machinery), then the mobile monitoring station 22 may commence monitoring the machine 12 and/or any peripheral units 14. It should be noted that hereinafter monitoring of machines refers to monitoring of both machines, and also workers and peripheral units. All monitoring data gathered by the mobile monitoring station 22 may then be transmitted to the central monitoring server 16 through wireless communication (e.g. via Wi-Fi, Bluetooth communication, cellular connection etc.), indicated with a dashed arrow, with a wireless communication unit 26.

In this way, there is no longer a need to physically connect a monitoring device to the machinery as the monitoring procedure is carried out with a mobile device and in a wireless fashion. Furthermore, the mobile monitoring station 22 also eliminates the need to employ a professional technician for physically connecting the machinery to a monitoring device. In a preferred embodiment, the mobile monitoring station is simply positioned near a machine (e.g. in a factory), such that monitoring of that machine may commence immediately since no physical connection is required and the monitoring station is therefore completely mobile and may be moved to monitor any machine.

It is appreciated that using such a mobile monitoring station may be highly advantageous in any environment requiring continuous monitoring, since the mobile monitoring station does not require physical connections and may therefore be easily installed and operated.

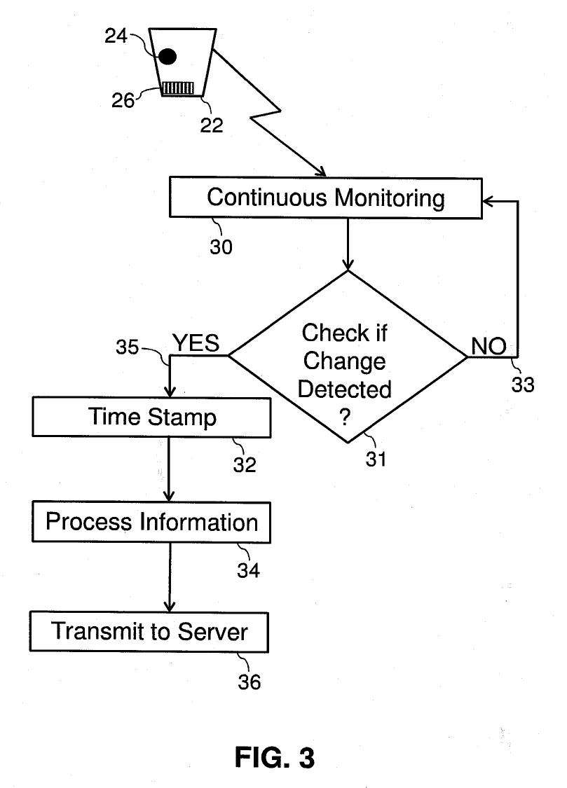

FIG. 3 shows a block diagram describing the monitoring process, with the abovementioned mobile monitoring station, and wherein the direction of arrows indicates the direction of information flow. The mobile monitoring station 22 may initiate a continuous monitoring process 30, with the at least one sensor 24 checking if a change has been detected 31, according to information from at least one of the following techniques:

1) Image processing.
2) Movement detection.
3) Sound processing.
4) Distance detection.

Each technique for detecting changes 31 in the machinery may be carried out using various features. Some exemplary features of these techniques are described hereinafter.

It is appreciated that information from the monitoring process may be continuously transmitted to the monitoring server for processing. In case that the processing at the server identifies a change then an appropriate signal may be sent back to the mobile monitoring station for continuing the monitoring process. In some embodiments, the processing of the information may be carried out in a dedicated processing unit at the mobile monitoring station.

The image processing technique is carried out with continuous image capturing (e.g. with a tablet's built-in camera), and ongoing processing of the captured images (carried out at the mobile monitoring station 22) may include at least one of the following features:
1.1) Barcode recognition—capturing standard barcodes or quick response codes (QR) as means of identifying particular items.
1.2) Color recognition—identifying whether an expected color has appeared (for example a color revealed if machine door is opened and the color is no longer blocked).
1.3) Optical character recognition (OCR)—capturing a display from an analog meter and recognizing specific characters.
1.4) Motion pattern—identifying whether an expected motion of the machine has occurred (for example a particular movement of a robotic arm).
1.5) Location analysis—identifying whether an item is at an expected location in the frame.
1.6) Optical encoder—using changes in an image as means to identify distance changes (for example an item appearing before and after a machine).
1.7) Frame location—capturing an image and checking whether the image moved (e.g. an item moving along the assembly line).

The movement detection technique is carried out with continuous motion sensing (e.g. with a tablet's built-in gyroscope and accelerometer), and ongoing processing at the mobile monitoring station 22 may include at least one of the following features:
2.1) Motion gestures—identifying whether an expected gesture of the machine has occurred.
2.2) Vibration patterns—identifying whether an expected vibration of the machine has occurred (for example a tablet mounted onto the machine and detects vibrations).
2.3) Compass—identifying whether an item is at an expected orientation.
2.4) Global positioning system (GPS)—identifying whether an item is at an expected location.

The sound processing technique is carried out with continuous sound sensing (preferably a tablet's built-in microphone), and ongoing processing at the mobile monitoring station 22 may include at least one of the following features:
3.1) Sound patterns—identifying whether an expected sound caused by the machine has been registered.
3.2) Voice command—identifying whether an expected voice command (e.g. of a machine operator) has been registered.
3.3) Sound volume peak—identifying whether an expected volume peak has been reached.

The distance detection technique is carried out with signal processing at the mobile monitoring station 22, based on data from a near field communication (NFC) sensor and/or a blue-tooth (BT) connection (e.g. built-in a tablet). The signal from the NFC or BT sensors changes according to the distance of the mobile monitoring station 22 from the machine 12 (for instance as shown in FIG. 2), as the reception of the signal changes with distance. For example, an item located at an expected proximity to the NFC sensor and/or a BT connected device along an assembly line. Other sensors may also be employed in order to detect changes in distance.

For example, a single identifier (e.g. a barcode) is used for identification of a specific machine and/or working tool (e.g. moving knife), and/or produced item, at the central monitoring server. This identification may be carried out with a predetermined encoding of the single identifier (e.g. a barcode), or alternatively based on temporary needs with a dynamic encoding.

Optionally, several monitored elements may be combined in order to retrieve a required parameter for information processing and also for determining the efficiency of the production. For example, using average item weight and raw material consumption rate (from the image processing and movement detection techniques) in order to deduce the total number of produced items.

In case that no change is detected 33, the mobile monitoring station 22 may continue monitoring 30 until a change is detected (for instance until a robotic arm of the machine moves). Conversely, in case that a change is detected 35, the mobile monitoring station 22 records the information together with a time stamp 32 for the detected change (for instance stopping time, setup time etc.). The mobile monitoring station 22 may then proceed with processing the recorded information 34, and finally transmits the resulting data 36 to the monitoring server. It should be noted that all data finally arriving to the monitoring server may be identified according to the time-stamps 32 of each action.

The resulting data (transferred to the server 36) may provide the at least one of the following indications on the operation of the machinery:
Progression (for instance progression of an item along the assembly line).
Rate (i.e. the production cycle timing).
Proper product (i.e. good/bad separation, and total yield).
Traceability (i.e. tracing location and status of an item, during processing).

The monitoring server may initiate retrieval of specific data if required during the operation of the machinery. As there is a two-way communication between the monitoring server 16 and the mobile monitoring station 22 (for instance as shown in FIG. 2), then a supervisor may request a different feature to be monitored by the mobile monitoring station 22 and then transferred back to the monitoring server 16. In production with long cycles, this possibility may be especially important as there may be lack of information for long periods of time (since no change will be detected, e.g. due to a malfunction).

Optionally, the mobile monitoring station may only transfer predetermined types of data in order to reduce loads on the central monitoring server. For example, if stopping time between progress reports is monitored, and a predetermined amount of time has passed without a progress report (or alternatively without a predetermined amount of cycles), then a stopping event may be initiated until progress resumes. In this way, while the mobile monitoring station gathers all information regarding the machinery, only the required data is transferred to the central monitoring server.

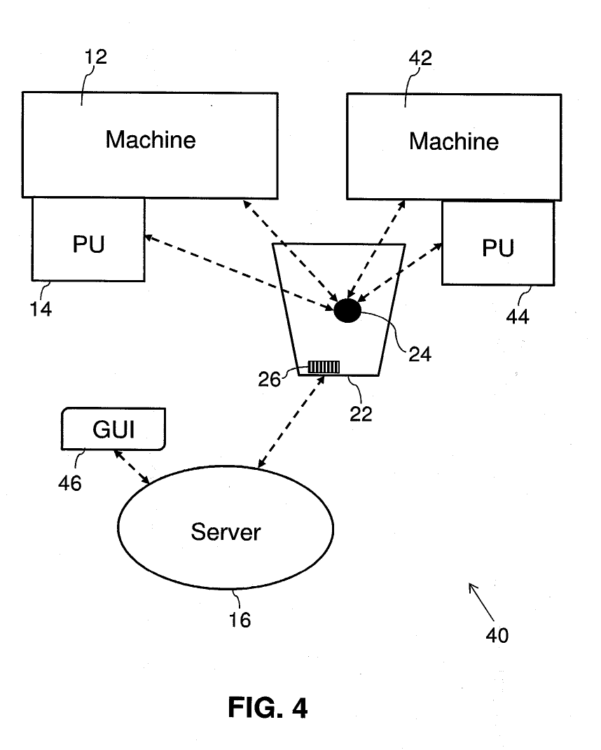

FIG. 4 schematically illustrates a mobile machinery monitoring system 40, which monitors two machines simultaneously, wherein the direction of arrows indicates the direction of information flow. A single mobile monitoring station 22 may monitor multiple machines using the at least one sensor 24. For example, a camera at the single mobile monitoring station 22, capturing images of a first machine 12 (and its peripheral unit 14) and also of a second machine 42 (and its peripheral unit 44) while giving a time stamp for each action of the respective machines. With proper identification of the machinery, the monitoring server 16 may accurately control the monitoring of both the first machine 12 and of the second machine 42, by differentiating asynchronous time-stamps from the machines (as the monitoring server may receive reports not necessarily in the order in which they occur). Moreover, reasons for automatic item rejection, or even halting production, may be recovered by identifying the precise actions from the respective time-stamps. It is appreciated that in a similar way, a single mobile monitoring station 22 may monitor multiple machines and peripheral units.

Accordingly, having a multiple number of such mobile monitoring stations that monitor the machinery may provide a traceable operation log that may be back traced to a specific event with statistical process control (SPC) over the entire production. For example, items marked “1-200” are packed in a case marked “1001”, and items marked “201-380” are packed in a case marked “1002”. If a negative test result is received for items “104-108” from the lab (e.g. for pharmaceutical products), then the central monitoring server may identify these items to belong in case “1001” and therefore stop further processing in this case.

In a further embodiment, several mobile monitoring stations may monitor a single machine with each mobile monitoring station monitoring a different feature in the machine.

Optionally, the mobile monitoring station 22 may further have an interactive display 46 (e.g. a touch-screen) as a graphical user interface (GUI) that may provide a production supervisor with the ability to retrieve required information on the machinery. For example, an interactive display 46 of a mobile monitoring station 22 that monitors several machines (as shown in FIG. 4) may be used by a production supervisor to check the production progress on site of a specific item in a specific machine. Furthermore, the production supervisor may manually provide additional production data, using the interactive display 46, as input for the mobile monitoring station 22.

In a further embodiment, the operator of manual or automatic production is monitored instead of monitoring a machine. Monitoring the operator may be required in cases where the majority of the production is done manually (and not by the machine). For instance, a human operator is required to wrap an item and move it for further processing in the production line (e.g. in a food processing factory).

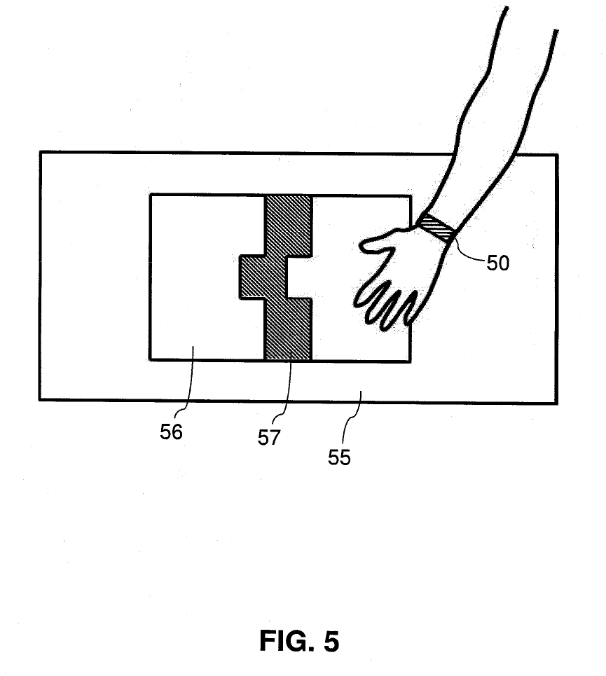

FIG. 5 schematically illustrates a wearable monitoring device 50. The wearable monitoring device 50 may be used to monitor human machine operators, or alternatively monitor automatic machines (for instance monitoring movement of a robotic arm). The wearable monitoring device 50 may detect movement (e.g. of a hand of the operator) as an indication of progression of the production. This feature may be especially useful in a production process where the majority of the production is done manually so that the abovementioned machine monitoring techniques are not useful, and only a wearable monitoring device may monitor the progress of the operator. By initially recording an expected movement (e.g. of a robotic arm), further movements detected by the wearable monitoring device 50 may be compared to optimal operation.

For example, monitoring of a machine 55, that is operated by an operator wearing the wearable monitoring device 50. The machine 55 may have a moving door 56 that in an open state (as shown in FIG. 5) reveals an inner space 57 having a specific coloring. Each processed item must be manually placed by the operator into the inner space 57. A camera in a mobile monitoring station (not shown) may monitor the operation of the machine 55 with image processing of the captured color in the inner space 57, and the wearable monitoring device 50 may monitor the number of movements carried out by the operator (thus monitoring the total number of items processed by the operator).

Finally, the mobile machinery monitoring system on its own or in combination with a wearable monitoring device, provides a simple and mobile solution for monitoring machinery. The mobile machinery monitoring system may be quickly installed at any existing factory and with minimal setup provide detailed monitoring.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A system for monitoring least one machine, the system comprising:
a central monitoring server, and
at least one mobile monitoring station, comprising:
at least one sensor; and
a wireless communication unit,
wherein said at least one sensor monitors the at least one machine, and wherein monitoring information from said at least one sensor is wirelessly transmitted to the central monitoring server using the wireless communication unit.

2. The system according to claim I, wherein the at least one mobile monitoring station is positioned in proximity to the at least one machine.

3. The system according to claim 1, wherein the at least one mobile monitoring station comprises a computing device.

4. The system according to claim 1, further comprising:
an interactive display coupled to the central monitoring server,
wherein the interactive display is configured to allow information to be sent to and retrieved from the central monitoring server.

5. The system according to claim 1, further comprising:
a wearable monitoring device wirelessly coupled to the central monitoring server, and mounted onto a moving article,
wherein the wearable monitoring device is configured to monitor movement of the moving article.

6. The system according to claim 5, wherein the moving article is the hand of an operator of the at least one machine.

7. The system according to claim 5, wherein the moving article is a robotic arm of the at least one machine.

8. The system according to claim 1, wherein the at least one sensor consists of at least one of the following components: a camera, a near field communication (NFC) sensor, a microphone, a gyroscope, and an accelerometer.

9. The system according to claim 1, wherein the wireless communication unit consists of at least one of the following components: Wi-Fi unit, Bluetooth unit, and a cellular communication unit.

10. The system according to claim 1, further comprising a processing unit, and wherein the processing unit is configured to allow processing the monitoring information from the at least one sensor.

11. A method for monitoring, the method comprising:
providing at least one sensor;
providing a wireless communication unit, coupled to the at least one sensor;
providing a central monitoring server;
initiating continuous monitoring with the at least one sensor;
processing the monitoring information; and
wirelessly transmitting processed information to the central monitoring server using the wireless communication unit.

12. The method according to claim 11, further comprising recording a time stamp.

13. The method according to claim 11, wherein the continuous monitoring comprises image capturing.

14. The method according to claim 11, wherein the continuous monitoring comprises sound capturing.

15. The method according to claim 11, wherein the information processing consists of at least one of the following techniques: image processing, movement detection, sound processing, and distance detection.

16. The method according to claim 11, wherein the information processing comprises at least one of the following processes: barcode recognition, color recognition, optical character recognition (OCR), motion pattern recognition, location analysis, optical encoding, and frame location.

17. The method according to 11, wherein the information processing comprises at least one of the following processes: motion gesture recognition, vibration pattern recognition, compass analysis, and global positioning system (GPS) recognition.

18. The method according to claim 11, wherein the information processing comprises at least one of the following processes: sound pattern recognition, voice command recognition, and volume peak recognition.
